(19) United States
(12) Patent Application Publication
(10) Pub. No.: US 2016/0335708 A1
(43) Pub. Date: Nov. 17, 2016

(54) SYSTEMS AND METHODS FOR ON-DEMAND MANUFACTURING

(71) Applicant: CATERPILLAR INC., Peoria, IL (US)

(72) Inventors: Stacey M. DELVECCHIO, Dunlap, IL (US); Judith SWANSON, Pekin, IL (US); Debra CONKLIN, Morton, IL (US); James Roger CARLBERG, Peoria, IL (US)

(73) Assignee: CATERPILLAR INC., Peoria, IL (US)

(21) Appl. No.: 14/709,457

(22) Filed: May 11, 2015

(51) Int. Cl. G06Q 30/06; G06Q 50/04; B29C 67/00

(52) U.S. Cl. CPC G06Q 30/0635; B29C 67/0051; G06Q 50/04; B33Y 10/00

(57) ABSTRACT

Systems and methods are disclosed for on-demand manufacturing. According to certain embodiments, the on-demand manufacturing system has a digital parts library and a pop-up factory. The digital parts library is configured to store manufacturing information of at least one part, and to receive an order for manufacturing one of the at least one part. The pop-up factory is housed in a mobile unit. The pop-up factory has a network connection, a 3D printer, and post-production equipment. The network connection is configured to receive the order and manufacturing information from the digital parts library over a network. The 3D printer is configured to print the part based on the manufacturing information. The post-production equipment is configured to finish the 3D-printed part based on the manufacturing information.

### TECHNICAL FIELD

The present disclosure relates generally to systems and methods for on-demand manufacturing, and more particularly, to systems and methods of using a mobile pop-up factory to manufacture products based on customers' demands.

### BACKGROUND

In industries that heavily rely on machines, such as mining and construction industries, the productivity hinges on engine and machine uptime. To keep the engines and machines running, parts frequently need to be installed or replaced. Thus, the availability of both first-fit and replacement parts is paramount for parts users in these industries.

Traditionally, the parts availability has been achieved through both building a fast delivery system and maintaining an inventory of parts. However, neither method is optimal. Regarding the delivery, even though some parts manufacturers, for example, have built a global delivery system that can deliver 95% of the parts to users within 24 hours, only 100% is good enough for the users to maximize productivity. Unavailability of even a single part may cause an engine, a machine, or an entire fleet to sit inoperable for extended hours. Regarding the inventory, parts dealers or users must spend precious capital on holding a vast variety and quantity of spare parts to ensure parts availability for moments of unexpected downtime. Moreover, a large portion of this inventory is stocked for emergency situations that occur infrequently and randomly.

Recent advances in additive manufacturing in general and commercial three-dimensional (3D) printing in particular, make it possible to accelerate delivery times and reduce inventory simultaneously. One method of manufacturing items on demand using 3D printing is described in U.S. Patent Application Publication No. 2015/0052024 (the '024 publication) by Apsley et al. published on Feb. 19, 2015. The '024 publication describes an on-demand manufacturing method and system used in e-commerce. A shopper orders an item and specifies a delivery method on an online service platform. The item is associated with a set of 3D manufacturing instructions. The online service platform selects a 3D manufacturing apparatus to manufacture the item based on the instructions. According to the shopper-specified delivery method, the selected 3D manufacturing apparatus may be located in a fulfillment center convenient for delivering the item to the shopper. The 3D manufacturing apparatus may also be installed in a vehicle so that the item can be produced while the vehicle is en route to deliver the item.

Although the system of the '024 publication may use 3D printing to make an item available for the shoppers quickly and potentially cheaply, the system is far from a self-contained, mobile pop-up factory capable of manufacturing industrial-grade parts any place of the world. In particular, the system does not integrate the 3D manufacturing apparatus with other computerized-numerical-control (CNC) machines, finishing equipment/processes, machining tools, etc. Thus, the '024 publication does not provide a complete solution to manufacture a finished part ready for immediate use.

The disclosed system is directed to overcoming one or more of the problems set forth above and/or other shortcomings in existing technologies.

### SUMMARY OF THE INVENTION

In one aspect, the present disclosure is directed to an on-demand manufacturing system including a digital parts library and a pop-up factory. The digital parts library is configured to store manufacturing information for at least one part, and to receive an order for manufacturing one of the at least one part. The pop-up factory is housed in a mobile unit. The pop-up factory includes a network connection configured to receive the order and manufacturing information from the digital parts library over a network. The pop-up factory also includes a 3D printer configured to print the part based on the manufacturing information. The pop-up factory further includes post-production equipment configured to finish the 3D-printed part based on the manufacturing information.

In another aspect, the present disclosure is directed to a method of operating an on-demand manufacturing system. The on-demand manufacturing system includes a pop-up factory and a digital parts library. The pop-up factory includes a 3D printer and post-production equipment. The method includes situating the pop-up factory at a desired location. The method also includes receiving by the digital parts library an order for manufacturing a part. The method further includes requesting manufacturing information for the part by the pop-up factory from the digital parts library. The digital parts library streams the manufacturing information to the pop-up factory. The 3D printer prints the part based on the manufacturing information. The 3D-printed part is finished based on the manufacturing information.

In yet another aspect, the present disclosure is directed to a pop-up factory for on-demand manufacturing. The pop-up factory includes a mobile unit housing a network connection, a 3D printer, and post-production equipment. The network connection is configured to receive an order for manufacturing a part and manufacturing information for the part from a digital parts library. The digital parts library is configured to store the manufacturing information and receive the order from a customer. The 3D printer is configured to print the part based on the manufacturing information. The post-production equipment is configured to finish the 3D-printed part based on the manufacturing information.

### BRIEF DESCRIPTION OF THE DRAWINGS

FIG. 1 is a schematic diagram illustrating an on-demand manufacturing system, according to an exemplary embodiment;

FIG. 2 is a schematic diagram illustrating a pop-up factory, according to an exemplary embodiment;

FIG. 3 is a schematic diagram illustrating an implementation of a digital parts library, according to an exemplary embodiment; and

FIG. 4 is a flow chart illustrating a method of on-demand manufacturing, according to an exemplary embodiment.

### DETAILED DESCRIPTION

Reference will now be made in detail to disclosed embodiments, examples of which are illustrated in the accompanying drawings. Wherever convenient, the same reference numbers will be used throughout the drawings to refer to the same or like parts.

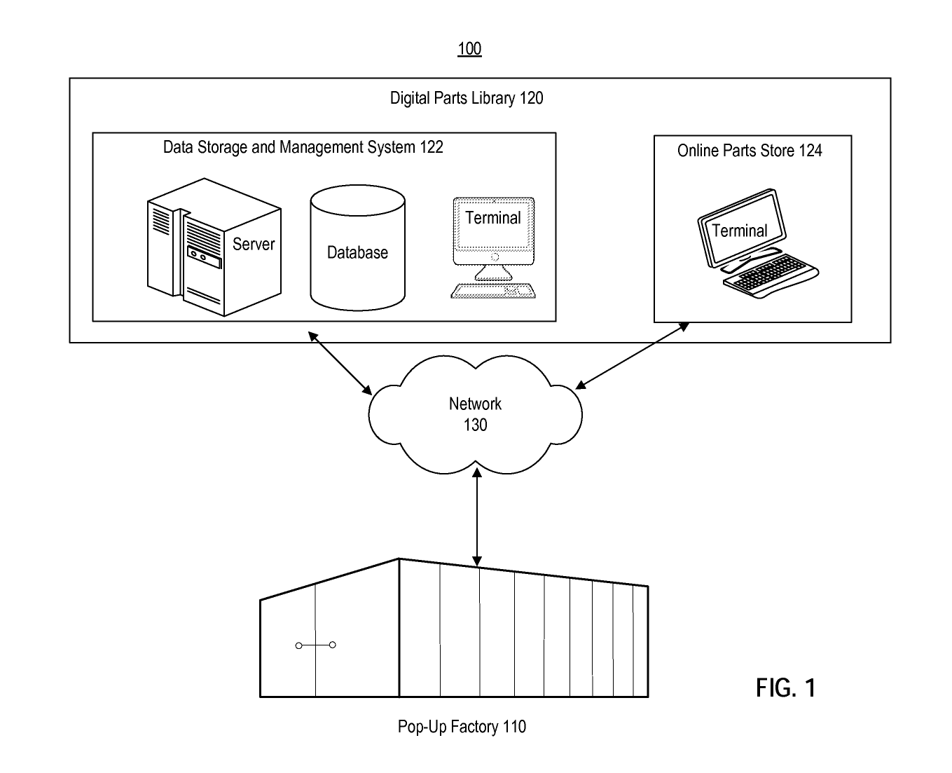

FIG. 1 is a schematic diagram illustrating an exemplary on-demand manufacturing system 100, consistent with the disclosed embodiments. As shown in FIG. 1, system 100 may include a pop-up factory 110, a digital parts library 120, and a network 130.

Pop-up factory 110 may be a self-contained, mobile unit including digital manufacturing equipment to manufacture parts on demand. In exemplary embodiments, the digital manufacturing equipment may include one or more 3D printers. Pop-up factory 110 also includes other equipment and tools necessary for manufacturing the parts. Like a traditional factory, an operator of the pop-up factory can use the equipment and tools provided in pop-up factory 110 to make a final product ready to be used by the parts user.

Pop-up factory 110 is configured to access digital parts library 120 and to receive manufacturing information relating to the parts from the library via network 130. Pop-up factory 110 is further configured to manufacture the parts based on the manufacturing information. For example, the manufacturing information may include 3D printing instructions, and the 3D printer is configured to use the instructions to produce the parts.

In exemplary embodiments, pop-up factory 110 may be housed in a trailer or a freight container that can be easily transported anywhere around the world. Pop-up factory 110 may be permanently or temporarily stationed at any or all of the following places: work sites of the machines or engines requiring the parts, branches of the machine or engine dealer, manufacturing facilities and distribution centers of the machine or engine manufacturer, traditional part supplier manufacturing sites, and third-party locations. An operator of pop-up factory 110 may be an engineer certified by the parts manufacturer.

To make the on-demand manufacturing a seamless experience for the user, digital parts library 120 is connected to pop-up factory 110 over network 130. Digital parts library 120 may include a data storage and management system 122, and an online parts store 124.

Data storage and management system 122 may include one or more hardware and/or software components configured to collect, store, analyze, evaluate, distribute, report, process, record, sort, and/or display manufacturing information of one or more parts. The manufacturing information is used by pop-up factory 110 to manufacture the parts. The manufacturing information may include specifications, 3D models, and 3D printing instructions of the parts. The manufacturing information may also include step-by-step instructions for how to complete any finishing or assembly required to create the finished parts.

Data storage and management system 122 may be hosted in a secure server maintained by the manufacturer. The server may be a general purpose computer, a mainframe computer, or any combination of these components. In certain embodiments, the server may be standalone, or it may be part of a subsystem, which may be part of a larger system. For example, the server may represent distributed servers that are remotely located and communicate over network 130. In addition, consistent with the disclosed embodiments, the server may be implemented as a server, a server system comprising a plurality of servers, or a server farm comprising a load balancing system and a plurality of servers. The server may include one or more processors, one or more memories, one or more storage devices, and/or one or more input/output (I/O) devices.

The processors may be configured to process data according to a set of programmable instructions or software stored in the memories. The processors may include one or more commercially available processing devices. The disclosed embodiments are not limited to any type of processors configured in the server.

The storage devices may include a volatile or non-volatile, magnetic, semiconductor, tape, optical, removable, non-removable, or other type of storage device or computer-readable medium. The storage devices may store programs and/or other information that may be used by the server. Moreover, the memories may include one or more devices configured to store instructions and data used by the processor to perform functions related to the disclosed embodiments. Both the storage devices and memories may store the manufacturing information of the parts.

The I/O devices may be configured to allow data to be received and/or transmitted by the server. The I/O devices may include one or more digital and/or analog communication devices that allow the server to communicate with other systems and devices, such as pop-up factory 110.

The server may also be communicatively connected to one or more databases storing manufacturing information of the parts. The server may be communicatively connected to the databases via network 130 or a dedicated link. The database may include one or more memory devices that store data, and are accessed and/or managed through the server. By way of example, the databases may include Oracle™ databases, Sybase™ databases, or other relational databases or non-relational databases, such as Hadoop sequence files, HBase, or Cassandra. The databases may also include computing components (e.g., database management system, database server, etc.) configured to receive and process requests for data stored in memory devices of the databases and to provide data from the databases.

In one embodiment, the server may be a cloud server that uses dynamic and extensible services through the Internet. That is, the cloud server may collect and populate digital manufacturing information via the Internet, and may store, analyze, evaluate, distribute, report, process, record, sort, and/or display the manufacturing information by using Internet-based computational resources. In addition, the databases may be cloud-based storage devices. Both the cloud server and cloud databases may implement various technologies to ensure the data is securely stored and transmitted by the cloud.

Data storage and management system 122 may further include a manufacturing information input interface configured for the manufacturer to input the manufacturing information of the parts to digital parts library 120. For example, the manufacturing input interface may be a terminal. The terminal may include an input device for engineers to input specifications and computer-aided design (CAD) models of the parts. The terminal may also be communicatively connected to a high-precision laser scanner, so that the scanner may measure 3D profiles of the parts and transmit the measurement results to the terminal.

Online parts store 124 may include one or more hardware and/or software components configured to provide a web service for customers to purchase parts. Online parts store 124 can be remotely accessed by any terminal over the Internet. For example, the terminal may be a computer located at a work site. The terminal may include a display device and an input device. The customer may use the terminal to browse and select the parts to be manufactured by pop-up factory 110.

In exemplary embodiments, online parts store 124 sends the order to pop-up factory 110. Based on the order information, pop-up factory 110 requests the manufacturing information for the ordered parts from data storage and management system 122. Data storage and management system 122 retrieves and streams the manufacturing information to pop-up factory 110, where the ordered parts are manufactured based on the manufacturing information.

Network 130 may be any type of network configured to provide communications between components of on-demand manufacturing system 100. For example, network 130 may be any type of network (including infrastructure) that provides communications, exchanges information, and/or facilitates the exchange of information, such as the Internet, a Local Area Network, or other suitable connections that enable the sending and receiving of information between the components of system 100.

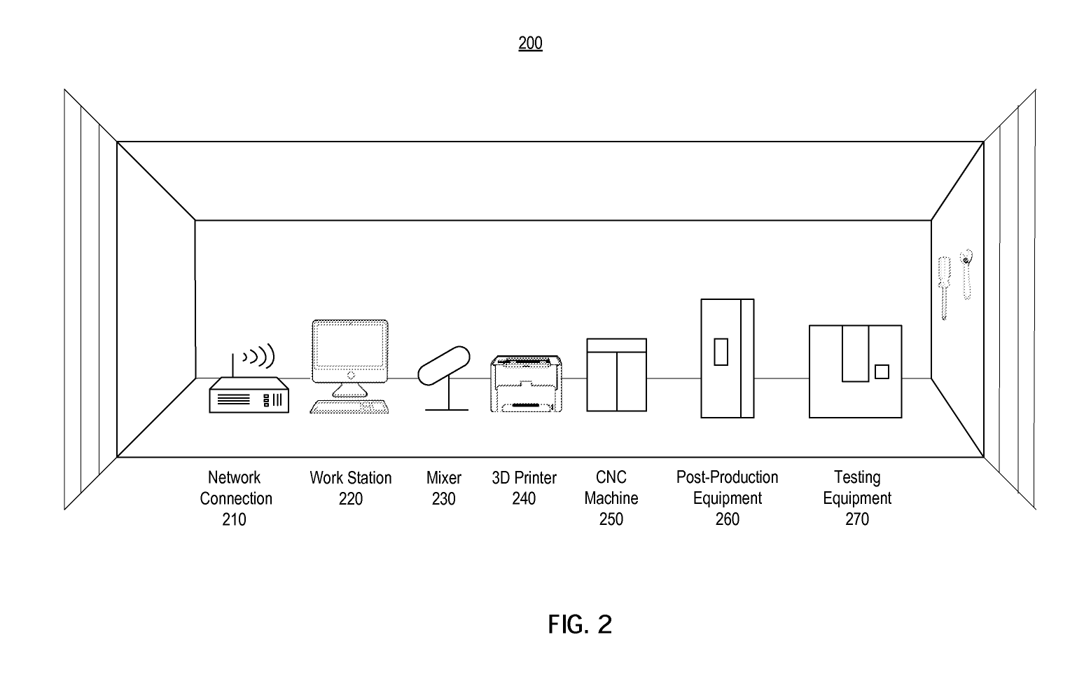

FIG. 2 illustrates an exemplary pop-up factory 200 having multiple components that cooperate to manufacture a product on demand. For example, the product may be a first-fit or a replacement part used in an engine or a machine. As shown in FIG. 2, pop-up factory 200 may include a network connection 210, a work station 220, a mixer 230, a 3D printer 240, a CNC machine 250, post-production equipment 260, and testing equipment 270.

Network connection 210 may be configured to connect to network 130 so that pop-up factory 200 can exchange information with digital parts library 120. Moreover, network connection 210 may be configured to inter-connect the equipment and tools within pop-up factory 200. For example, network connection 210 may include a wired or wireless router.

Work station 220 may be a computer configured to receive, transmit, process, evaluate, and/or display manufacturing information of the part. The information may include specifications, 3D models, computer aided design (CAD) models, and manufacturing instructions of the part. Work station 220 may also be configured to receive an order from online parts store 124. Work station 220 may further be configured to control other equipment and tools in pop-up factory 200 based on the manufacturing information.

Mixer 230 is configured to mix and prepare 3D-printable materials to be fed into 3D printer 240. The 3D printable materials may be resins, metals, thermoplastics, biocompatible materials, etc. The 3D printable materials may be recycled from used parts traded in by the parts users. To ensure the quality of the parts produced by pop-up factory 200, the 3D printable materials may be required to be certified or supplied by the parts manufacturer.

3D printer 240 is configured to print the part based on the 3D printing instructions. 3D printer 240 may include an extruder. Work station 220 or a controller carried by 3D printer 240 may control the extruder to transform the 3D printable materials into the part.

CNC machine 250 is configured to create additional desired features on the part produced by 3D printer 240. CNC machine 250 includes a computer and computer-controlled tools such as lathes, mills, saws, drills, lasers, welders, cutters, etc. The computer may execute a CNC program to manipulate the part and tools to perform desired operations at precise locations on the part.

Post-production equipment 260 may be configured to perform processes such as painting, cleaning, and finishing the produced part. For example, post-production equipment 260 may include a sprayer to deposit a rust-resistant layer on the surface of the part.

In some embodiments, if the part is an assembly including multiple components, 3D printer 240 may be configured to print each component separately. Subsequently, all the printed components may be assembled by post-production equipment 260 or manually assembled by the factory operator based on the assembly instructions. Post-production equipment 260 may be configured to assemble the multiple components into the final part. For example, post-production equipment 260 may include an industrial robot to complete the assembly based on the assembly instructions.

Testing equipment 270 is configured to test the performance and function of the part. For example, testing equipment 270 may include an ultrasonic detector that uses ultrasonic vibrations to detect cracks in the part.

Pop-up factory 200 may also include other tools that may be routinely used by the operator. These tools may include hammers, screw drivers, etc.

The configuration of pop-up factory 200 is highly flexible. One of ordinary skill in the art understands that the exact equipment and tools included in pop-up factory 200 may be tailored according to the parts to be manufactured. For example, if pop-up factory 200 is dedicated to manufacture simple and small parts, CNC machine 250 may be omitted from the factory. However, if pop-factory 200 manufactures complicated parts that need special treatment, additional equipment and tools may be added to the factory.

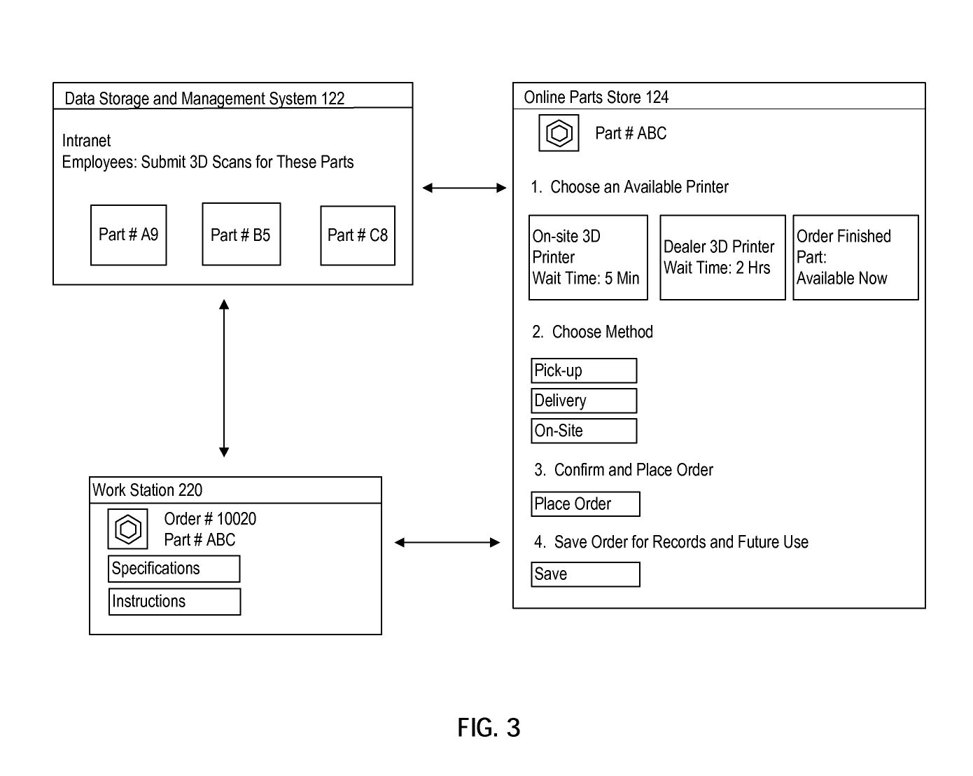

FIG. 3 illustrates an implementation of digital parts library 120, according to an exemplary embodiment. Referring to FIG. 3, data storage and management system 122 may collect manufacturing information relating to various parts via a manufacturing information input interface. The parts manufacturer may identify parts suitable to be manufactured by a pop-up factory in general and a 3D printer in particular, and determine whether data storage and management system 122 stores the most updated 3D digital files for these parts. The manufacturer then collects the missing 3D digital files. In one embodiment, the manufacturer may crowdsource 3D scans from its employees. The manufacturer may display on the manufacturing information interface a list of parts that need 3D scans. The interface is accessible by the manufacturer's employees via its Intranet. An employee may submit a 3D scan. These scans may serve as a starting point from which the manufacturer's engineers can develop high-quality 3D digital files and generate 3D printing instructions.

The parts user may use online parts store 124 to browse the parts that can be 3D printed in pop-up factories. After the user selects a part, online parts store 124 may show a list of pop-up factories that can produce the part, and respective wait times. In the example illustrated in FIG. 3, a pop-up factory located at the work site can start to produce the selected part in five minutes, while a pop-up factory in a nearby dealer branch has a wait time of two hours. Moreover, if the dealer has the selected part in its inventory, the user has the option to order the finished part from the dealer right away. Based on where the order is placed, the user may pick up the order at the selected pop-up factory or have it shipped to a work site. After the user place the order, online parts store 124 may be configured to save the user's order history. This history may be used to simplify the user's purchasing experience in the future, or may be used by the parts manufacturer to analyze the user's purchasing pattern to better tailor the pop-up factories to the user's needs.

When online parts store 124 sends the order information to the selected pop-up factory, work station 220 in the factory instantly adds the part number to the production queue. The factory operator reviews the production queue and decides which part to produce in which order. Work station 220 also accesses data storage and management system 122 to retrieve manufacturing information for the ordered part and presents the information to the operator.

In exemplary embodiments, digital parts library 120 may have features to protect the parts manufacturer's intellectual property and proprietary information regarding the parts designs. For example, data storage and management system 122 may stream the manufacturing information to pop-up factories in encrypted files so that only personnel authorized by the manufacturer can have full access to the information. Moreover, the 3D printing instructions and CNC programs are directly streamed to the 3D printers and CNC machines to minimize the exposure to unauthorized personnel.

### INDUSTRIAL APPLICABILITY

Although the disclosed embodiments may be described in connection with a parts manufacturer, a parts dealer, and a parts user, it is to be understood that the disclosed embodiments are not limited to these parties and may, in fact, be applied to any other parties directly or indirectly involved in on-demand manufacturing. It is also to be understood that the disclosed embodiments are not limited to manufacturing parts.

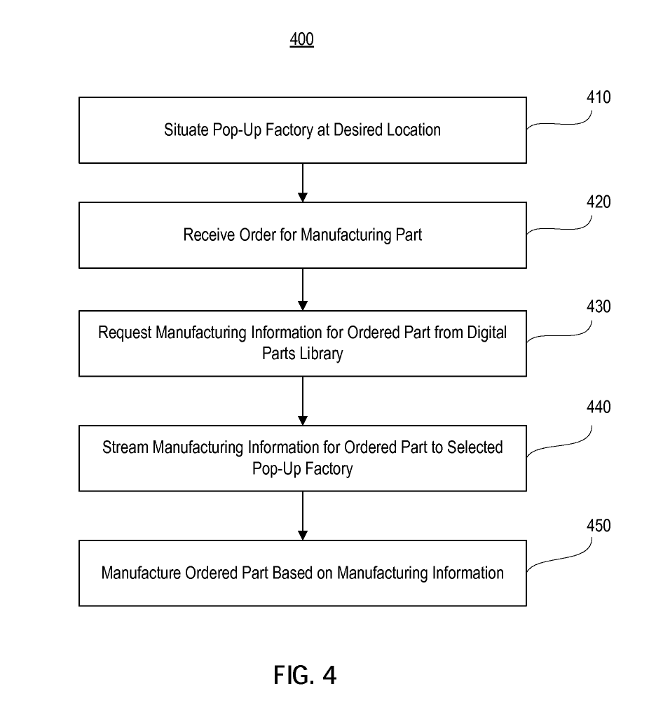

The disclosed on-demand manufacturing system 100 combines a movable pop-up factory and a digital parts library to manufacture parts at any desired location. This way, the disclosed on-demand manufacturing system 100 may improve parts accessibility for the parts users, and reduce inventory costs for the manufacturers and dealers. The operation of on-demand manufacturing system 100 will now be explained with reference to FIG. 4.

In step 410, pop-up factory 110 is situated at a desired location. Pop-up factory 110 may be permanently or temporarily stationed at this location. The choice of the location may be based on the business needs of the end customer, parts manufacturers, engine and machine manufacturers and dealers.

The pop-up factory may be stationed at the user work sites. Users stationed far from a dealer location may be better served by on-site production capabilities to minimize lead time and downtime.

The pop-up factory may be stationed at the dealer branches. The on-demand manufacturing capabilities may help the dealers to reduce finished parts inventory and free up warehouse space. In addition, because many dealer branch locations are in close proximity to key users, dealers may be well positioned to operate the pop-up factory to serve many customers in the vicinity.

The pop-up factory may be stationed at a neutral third-party location. Sometimes, work sites for multiple users may be clustered in a region where a dealer does not have a branch. The dealer may operate the pop-up factory in the region to serve the multiple users without opening a new branch.

The pop-up factory may also be stationed at the manufacturer's manufacturing facilities and distribution centers. The manufacturer may use the 3D printing capacities of the pop-up factory to produce parts more efficiently. This arrangement is suitable for parts with complex production or assembly processes, or low-volume parts that are too large to be manufactured by a dealer.

In step 420, online parts store 124 receives an order from the parts user or customer for manufacturing a part. The user may also use online parts store 124 to select which pop-up factory to fulfill the order, and specify the method of receiving the finished part. Online parts store 124 then sends the order information to the selected pop-up factory.

In step 430, based on the order information, the selected pop-up factory 110 sends a signal to digital parts library 120 requesting the manufacturing information for the ordered part from the library.

In step 440, data storage and management system 122 streams manufacturing information for the ordered part to the selected pop-up factory 110. The manufacturing information may include: specifications of the part, 3D profiles of the part, 3D printing instructions, CNC programs, post-production and finishing instructions, etc.

In step 450, the selected pop-up factory 110 manufactures the ordered part based on the manufacturing information. In particular, the 3D printer produces the ordered part according to the 3D instructions. If necessary, post-printing procedures may be performed. For example, the CNC machine may be used to create additional features on the printed part. Post-production equipment may be used to perform finishing processes on the printed part. Testing equipment may be used to examine the quality and performance of the finished part. Finally, the finished part is either delivered to or picked up by the parts user.

Several advantages over the prior art may be associated with the disclosed on-demand manufacturing system 100. First, by integrating the 3D printer with the CNC machine, post-production equipment, and testing equipment, pop-up factory 110 can be used to produce large and complex parts that are ready for use. Second, with direct control over digital parts library 120, the parts manufacturers can protect their intellectual property and proprietary information, even if pop-up factory 110 is sold to or operated by the parts dealer, the parts user, or a third party. Third, because pop-up factory 110 receives manufacturing information from digital parts library 120 over network 130, the parts manufacturers may remotely control the manufacturing processes in pop-up factory 110 by updating digital parts library 120.

It will be apparent to those skilled in the art that various modifications and variations can be made to on-demand manufacturing system 100. Other embodiments will be apparent to those skilled in the art from consideration of the specification and practice of disclosed on-demand manufacturing system 100. It is intended that the specification and examples be considered as exemplary only, with a true scope being indicated by the following claims and their equivalents.

What is claimed is:

1. An on-demand manufacturing system, the system comprising:
a digital parts library configured to:
store manufacturing information for at least one part, and
receive an order for manufacturing one of the at least one part; and
a pop-up factory housed in a mobile unit, the pop-up factory comprising:
a network connection configured to receive the order and manufacturing information from the digital parts library over a network;
a 3D printer configured to print the part based on the manufacturing information; and
post-production equipment configured to finish the 3D-printed part based on the manufacturing information.

2. The on-demand manufacturing system of claim 1, wherein the digital parts library includes a manufacturing information input interface configured to receive the manufacturing information.

3. The on-demand manufacturing system of claim 1, wherein the digital parts library is further configured to:
list a plurality of pop-up factories available for manufacturing the part;
indicate a wait time for each of the plurality of pop-up factories;
receive a customer selection of a pop-up factory from the plurality of pop-up factories to manufacture the part; and
send the order to the selected pop-up factory.

4. The on-demand manufacturing system of claim 1, wherein the part is an assembly including multiple components, the 3D printer is further configured to print each of the multiple components, and the post-production equipment is further configured to assemble the printed components into the part.

5. The on-demand manufacturing system of claim 1, wherein the pop-up factory is situated at one of a parts user work site, a parts dealer branch, a parts manufacturing facility, a parts distribution center, and a third-party location.

6. The on-demand manufacturing system of claim 1, wherein the pop-up factory further comprises a mixer configured to develop 3D-printable material for the 3D printer based on the manufacturing information.

7. The on-demand manufacturing system of claim 1, wherein the pop-up factory further comprises a CNC machine configured to create additional features on the 3D-printed part.

8. The on-demand manufacturing system of claim 1, wherein the digital parts library is configured to transmit the manufacturing information to the pop-up factory in encrypted digital files.

9. The on-demand manufacturing system of claim 1, wherein the manufacturing information comprises one or more of specifications of the part, 3D profiles of the part, 3D printing instructions, CNC programs, and instructions to finish the 3D-printed part.

10. A method of operating an on-demand manufacturing system comprising a pop-up factory and a digital parts library, the method comprising:
situating the pop-up factory at a desired location, the pop-up factory comprising a 3D printer and post-production equipment;
receiving by the digital parts library an order for manufacturing a part;
requesting manufacturing information for the part by the pop-up factory from the digital parts library;
streaming the manufacturing information from the digital parts library to the pop-up factory;
printing the part by the 3D printer based on the manufacturing information; and
finishing the 3D-printed part based on the manufacturing information.

11. The method of claim 10, wherein the desired location is one of a parts user work site, a parts dealer branch, a parts manufacturing facility, a parts distribution center, and a third-party location.

12. The method of claim 10, wherein receiving by the digital parts library the order for manufacturing the part further comprises:
listing a plurality of pop-up factories available for manufacturing the part;
indicating a wait time for each of the plurality of pop-up factories;
receiving a customer selection of a pop-up factory from the plurality of pop-up factories to manufacture the part;
sending the order information to the selected pop-up factory.

13. The method of claim 10, wherein streaming the manufacturing information from the digital parts library to the pop-up factory comprises:
streaming the manufacturing information in encrypted digital files.

14. The method of claim 10, wherein the pop-up factory further comprises a mixer, the method further comprising:
developing 3D-printable material for the 3D printer by the mixer based on the manufacturing information.

15. The method of claim 11, wherein the pop-up factory further comprises a CNC machine, the method further comprising:
creating additional features on the 3D-printed part by the CNC machine based on the manufacturing information.

16. A pop-up factory for on-demand manufacturing, the pop-up factory comprising:
a mobile unit configured to house:
a network connection configured to receive an order for manufacturing a part and manufacturing information for the part from a digital parts library, the digital parts library being configured to store the manufacturing information and receive the order from a customer;
a 3D printer configured to print the part based on the manufacturing information; and
post-production equipment configured to finish the 3D-printed part based on the manufacturing information.

17. The pop-up factory of claim 1, wherein the part is an assembly including multiple components, the 3D printer is further configured to print each component of the multiple components, and the post-production equipment is further configured to assemble the printed components into the part.

18. The pop-up factory of claim 1, further comprising a mixer configured to develop 3D-printable material for the 3D printer based on the manufacturing information.

19. The pop-up factory of claim 1, further comprising a CNC machine configured to create additional features on the 3D-printed part based on the manufacturing instructions.

20. The pop-up factory of claim 1, further comprising testing equipment configured to test the finished part.
